(19) United States
(12) Patent Application Publication
(10) Pub. No.: US 2018/0232937 A1
(43) Pub. Date: Aug. 16, 2018

(54) System and Method for Implementing Virtual Reality

(71) Applicants: Philip Moyer, Berwyn, PA (US); H Lawrence Strange, JR., Wilmington, DE (US)

(72) Inventors: Philip Moyer, Berwyn, PA (US); H Lawrence Strange, JR., Wilmington, DE (US)

(21) Appl. No.: 15/895,156

(22) Filed: Feb. 13, 2018

Related U.S. Application Data
(60) Provisional application No. 62/458,912, filed on Feb. 14, 2017.

(51) Int. Cl. G06T 15/00; G06T 19/00; H04L 29/06

(52) U.S. Cl. CPC G06T 15/005; H04L 67/12; H04L 63/0853; G06T 19/006

(57) ABSTRACT

Techniques are disclosed for improving virtual reality experience by optimizing spatial mapping coordination and device setup while maintaining up-to-date content and managing security. An augmented reality unit can map virtual reality content and assets related to a physical space in a virtual environment. The virtual reality content and assets can be cached in a storage architecture and accessed by other augmented reality units, wherein the other augmented reality units can be in the same mapped physical space to utilize the cached content and assets generated by the first augmented reality unit, thereby eliminating the need for subsequent augmented reality units to map dimensions and objects in the same space. Similarly, updated contents and/or assets placed in a virtual environment by one augmented reality unit can be accessed by other augmented reality units. Various authentication techniques and security protocols can be implemented to grant access to credentialed augmented reality units.

### CROSS-REFERENCE TO RELATED APPLICATIONS

This application claims the benefit of U.S. Provisional Patent Application No. 62/458,912, filed Feb. 14, 2017, which is hereby incorporated by reference in its entirety.

### FIELD OF THE INVENTION

The present invention relates generally to virtual reality, augmented reality, and mixed reality systems. More particularly, the present invention is directed to systems and methods configured to facilitate secure and optimal implementation of virtual reality, augmented reality, and/or mixed reality systems.

### BACKGROUND OF THE INVENTION

Various types of systems and methods for providing augmented and virtual reality are known in the art. Virtual reality comprises a computer-generated simulation of a three-dimensional image or environment that can be interacted with in a seemingly real or physical way by a person wearing headsets, controllers, and/or other devices equipped with sensors. Typically, processing these three-dimensional images or environments require significantly more resources than traditional computing. More specifically, three-dimensional representations are significantly larger in size, take more CPU processing capacity, and require a higher speed network connection or Wi-Fi and processing power, thereby causing power or battery drain.

Additionally, three-dimensional headsets and other controllers have limited storage and processing capacity. In this regard, storing and displaying various display resolution and display modes, as well as other data, are difficult for a single headset to maintain. Additionally, mapping a virtual environment requires coordination among users and multiple devices. Where additional or new content needs to be downloaded, download times and capacity limit the length and depth of content experience. Furthermore, it is difficult to set up headsets and upload each content (i.e., upon connecting the headsets to a network) because existing systems do not allow for automatic setup and orientation. This can be a difficult and time-consuming process that requires technical expertise. In this regard, an external system that is configured to pre-cache frequently used content and that maintains content to deliver up-to-date content is desired.

Moreover, mixed reality and augmented reality systems must orient themselves to the physical surroundings. In this regard, the dimensions and physical objects in a space must be mapped. This is a time-consuming process that each individual headset wearer must go through each time the user visits a space that is different from the last. Currently, there is no central repository of spaces to draw on based on the proximity of a headset.

Further, existing spatial anchors that use spatial data or spatial mapping in coordinate systems may experience drift, as spatial anchors cannot be moved once they are placed. In this regard, it is difficult to place three-dimensional objects logically in a way that all users would see it in the same location in a virtual environment because the real-time location of spatial objects is not tracked against the spatial map.

Finally, existing virtual reality systems do not provide adequate security and reliability that are needed for providing a seamlessly mixed reality experience. Additionally, content must be able to securely and verifiably updated on three-dimensional systems while adhering to certain regulatory constraints. In this regard, a dynamic system that provides a dedicated computer configured to automatically optimize virtual reality implementation while having an uninterruptible network connection is needed. In view of the aforementioned disadvantages of existing virtual reality systems, the invention described herein addresses these problems.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 shows a high-level architecture of the exemplary embodiment of the present system.

FIG. 2 shows a block diagram of one or more exemplary computing devices for implementing virtual reality.

FIG. 3 shows a flow diagram of an example process for mapping a virtual environment and caching location-specific virtual reality content to make virtual reality contents available to one or more users.

FIG. 4 shows a flow diagram of an example process for maintaining location-specific virtual reality assets.

FIG. 5 shows a flow diagram of an example process for conducting security and auditing management.

### DETAILED DESCRIPTION OF THE INVENTION

This disclosure is directed to techniques for improving virtual reality experience by optimizing spatial mapping coordination and device setup while maintaining up-to-date content and managing security. It is noted that as used herein, the terms “virtual reality,” “augmented reality,” and “mixed reality” are used interchangeably unless the context clearly suggests otherwise. It is also noted that as used in this application, the terms “component,” “module,” “system,” “interface,” or the like are generally intended to refer to a computer-related entity, either hardware or a combination of hardware and software. For example, a component can be but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

In various embodiments, the system provides a hardware unit comprising a memory unit having a set of instructions stored thereon, wherein the memory unit is operatively connected to one or more processing units for executing the instructions to provide a 3D network management, storage and content manager, physical space management, processing management, security and auditing management, and user management. Preferably, the processing units comprise one or more graphics processing units (GPUs) for conducting graphics operations and can be governed by a management console and/or an administrative entity. The GPUs can be made available to all or some of the connected augmented reality units in the system, or only to shared virtual reality content accessible to all augmented reality units.

The processing unit is operatively connected to a network interface device (e.g., a router) for connecting to a bounded secure high-speed network comprising 5G, WiMAX, Ethernet, Wi-Fi, cellular connectivity, or any combination thereof, wherein the network can be tethered to an external network so that it can serve as an intelligent proxy for all requests for content. During life-critical or mission-critical activity, the network can limit or restrict external communications to prevent interruptions and improve the content experience for users. In various embodiments, the present network and/or system can be air-gapped so that it is fully functional in a disconnected state.

The storage and content manager automatically detects the physical location of all connected augmented reality units, wherein the augmented reality units can comprise headsets or head mounted display with sensors such as cameras that are integral to the headsets or externally tethered thereto. The storage and content manager can receive requests for specific virtual reality contents by interrogating the type of request. The storage and content manager can also detect the content being downloaded through its proxy from an augmented reality unit and automatically cache the content that is used by any connected augmented reality units into its storage architecture. Preferably, identifiers associated with each of the augmented reality unit identifiers are provided in data sent to and from the augmented reality units.

The 3D network management is configured to make available any room-specific content and correlating configuration to connected augmented reality units. In various embodiments, the 3D network management delivers specific content to an augmented reality unit based on one or more criteria, such as location. In this way, each connected augmented reality unit is automatically configured to set up, store, and read content from the storage within the network based on the physical location and/or room the unit is located in. The storage and content manager keeps the content up-to-date by automatically downloading any changed content at regular intervals. Additionally, the storage and content manager can de-duplicate all stored assets on a scheduled basis. The storage and content manager also dynamically adjusts and delivers the appropriate resolution and/or polygon count for the 2D or 3D assets being requested.

Each user of an augmented reality unit can map a room using spatial mapping and store mapping information or data that can be made available for all of the other users of an augmented reality unit in the network. Each room within a virtual environment can be grouped or organized by, for example, location and content related to the mapping can be synchronized among grouped rooms.

Users (i.e., operators of augmented reality units within the system) can also be organized by groups, wherein data associated with the users and groups can be inherited from an active directory or other credential management systems. Users and groups can manage access to content, processing, Wi-Fi network, and physical space data via, for example, a management console and/or an administrative entity.

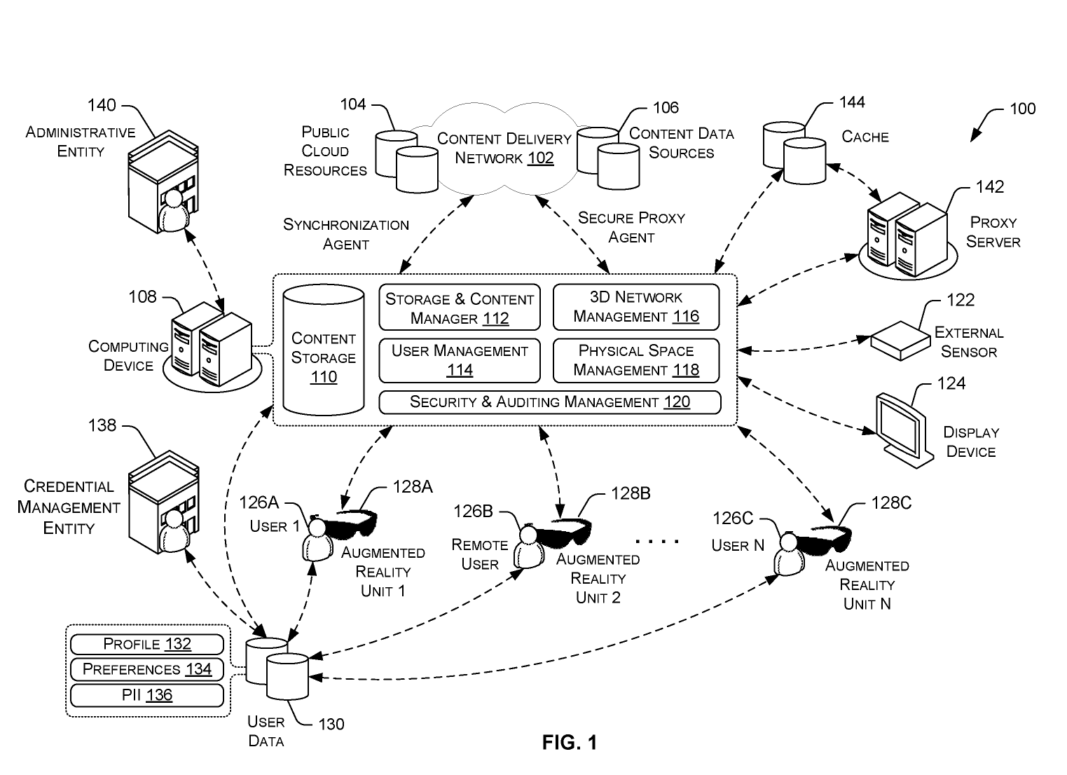

The techniques described herein may be implemented in a number of ways and various modifications obvious to one skilled in the art are deemed to be within the spirit and scope of the present invention. Accordingly, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” or “at least one” unless specified otherwise or clear from context to be directed to a singular form. Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media. Example implementations are provided below with reference to the following FIGS. 1 through 5.

### Example Architecture

Referring now to FIG. 1, there is shown a context diagram of an exemplary embodiment of the present system. The system 100 comprises a storage and content manager 112, 3D network management 116, user management 114, physical space management 118, security and auditing management 120, and storage 110. The storage and content manager 112, 3D network management 116, user management 114, physical space management 118, security and auditing management 120, and content storage 110 can execute on one or more computing devices 108 or computing nodes in a network, wherein the network can comprise a secure high-speed network comprising 5G, WiMAX, and/or so forth. The network may also be a local area network (LAN), a larger network such as a wide area network (WAN), or a collection of networks, such as the Internet. It is contemplated that the network comprises a secure network that can be protected via, for example, user and password management and/or other authentication protocols. In some embodiments, the network can provide user authentication, encryption, access authorization, Internet Protocol (IP) connectivity, and other access, calculation, modification, and/or functions. The computing device 108 can be distributed processing nodes that are scalable according to workload demand. In various embodiments, the computing device 108 can include general purpose computers, such as desktop computers, tablet computers, laptop computers, servers, as well as smart phones, mobile devices, and so forth. However, in other embodiments, the computing device 108 can be in the form of virtual machines, such as virtual engines (VE) and virtual private servers (VPS). The computing device 108 can be governed by a management console and/or an administrative entity.

In addition to the content storage 110, the computing device 108 can store data in a distributed storage system, in which data may be stored for long periods of time and replicated to guarantee reliability. Accordingly, the computing device 108 may provide data and processing redundancy, in which data processing and data storage may be scaled in response to demand. In various embodiments, the computing device 108 can be connected to a cloud layer that may provide software utilities for managing computing and storage resources. For example, the cloud layer may provide a generic user interface for handling multiple underlying storage services (e.g., local servers, Amazon AWS™, Digital Ocean™, etc.) that stores the data collected from various data sources (e.g., an augmented reality unit 126A-126C). Further, in a networked deployment, new computing devices 108 can be added on the fly without affecting the operational integrity of the storage and content manager 112, 3D network management 116, user management 114, physical space management 118, security and auditing management 120, and storage 110.

The computing device 108 can be operatively connected (e.g., via Bluetooth) to a variety of external devices such as one or more sensors 122 and display devices 124. Without limitation, the sensors 122 can comprise imaging sensors (e.g., cameras), motion detectors, tactile sensors, microphones, speedometers, and/or so forth. Data that is collected by the sensors 122 can be transmitted to the computing device 108 for processing. Without limitation, the display device 124 can comprise various types of LED, LEC, plasma monitors and/or projectors that can display 2D and/or 3D images. The display device 124 is configured to mirror images that are shown on the one or more augmented reality units 128A-128C. In this way, users who are not wearing an augmented reality unit (e.g., a remote user) can view virtual environment from a point of view of users wearing the augmented reality units 128A-128C.

As implied above, the computing device 108 is configured to establish a connection with one or more augmented reality units 128A-128C, wherein the augmented reality units 128A-128C are network-enabled devices comprising a network interface controller or other similar means. The augmented reality units 128A-128C can be operated by one or more users 126A-126C, wherein the one or more users can be remote users. The computing device 108 can be made available to all or some of the connected augmented reality units 128A-128C in the system, or only to shared virtual reality content on all augmented reality units 128A-128C. The augmented reality unit 128A-128C includes a head-mounted display that can comprise a wearable device such as a headset, goggles, or glasses that can provide a 3D display or images, 2D display or images, hologram display or holographic images. In various embodiments, the augmented reality unit 128A-128C includes a personal media player device, a wireless web-watch device, a personal headset device, an application specific device, a virtual reality device, a holographic send and receive notice or a hybrid device that include any of the aforementioned functions. Further, the augmented reality unit 128A-128C can be removably attached to the computing device 108, whereby the augmented reality unit 128A-128C can comprise a headset and the computing device 108 can comprise a mobile device (e.g., a smart phone) that can connect to the augmented reality unit 128A-128C to create an augmented reality device.

The augmented reality units 128A-128C can work in conjunction with another electronic device (e.g., a controller unit, a secondary augmented reality unit, external input/output devices, etc.) or as a standalone device. In various embodiments, the augmented reality unit 128A-128C comprises a wearable mount having a display processor, one or more sensors such as cameras and gesture sensors (i.e., for detecting a user's 126A-126C bodily movements such as hand gestures) and microelectromechanical systems (MEMS) sensors (e.g., accelerometer, GPS, solid state compass, etc.), and user input controls that are operatively connected to one or more displays that is disposed in front of the user's 126A-126C eyes. The augmented reality unit 128A-128C can include cameras that are configured to receive real environment input surrounding the user 126A-126C such that a display processor can overlay real scenes captured via the cameras with information (e.g., notifications, graphical indicia, etc.) for display on the one or more displays in an augmented reality mode. In this regard, one or more holographic optical elements can be used. In various embodiments, a user 126A-126C can view information via a hologram display on the augmented reality unit 128A-128C. It is noted that various settings and/or features such as the overlay and the hologram display can be turned on and off manually by the user 126A-126C.

Upon connection to at least one augmented reality unit 128A-128C, the storage and content manager 112 identifies the geographical location of the unit 128A-128C via a variety of data collection mechanisms and/or geolocation services. For instance, the storage and content manager 112 can determine the location of an augmented reality unit 128A-128C using a Global Positioning System (GPS), control plane locating techniques, self-reported positioning techniques, cellular tower triangulation, real-time locating, satellite tracking, network routing address, IP address, and/or so forth. The location information of an augmented reality unit 128A-128C can be used to tag information or data sent to or received from the augmented reality unit 128A-128C.

Additionally, the storage and content manager 112 receives a request for a 2D photo and video assets, 3D holographic assets, and/or other virtual reality content (i.e., various digital media relating to virtual reality, augmented reality, and mixed reality environments, etc.) from a connected augmented reality unit 128A-128C. The request can include one or more identifying information associated with the requesting augmented reality unit 128A-128C. In various embodiments, the storage content manager 112 can automatically query or prompt the augmented reality unit 128A-128C to request content from the storage and content manager 112 if the storage content manager 112 does not receive a request from the augmented reality unit 128A-128C upon establishing a connection. Assets and contents obtained from one augmented reality unit 128A-128C can be cached or stored in a cache 144 or a storage architecture for access by another augmented reality unit 128A-128C.

In response to the request for certain virtual reality content, the storage and content manager 112 can retrieve from public cloud resources 104, content data sources 106, and/or other data sources the requested content (e.g., holographic image libraries, 360-degree videos in public domain, etc.). In this regard, the computing device 108 can establish connection to one or more content delivery network 102 or content distribution network in order to access the virtual reality content from the various data sources, wherein the connectivity to the one or more content delivery network 102 can be configurable so that the computing device 108 can be connected to some or all of the content delivery networks 102 at any given time. The content delivery network 102 comprises a network of proxy servers 142 and their data centers such as public resources 104 and content data sources 106 that can provide virtual reality content and/or related data. In various embodiments, the storage and content manager 112 can retrieve from the content storage 110 the requested content for transmission to the requesting augmented reality unit 128A-128C. The storage and content manager 112 also dynamically adjusts and delivers the appropriate resolution for any 2D or 3D assets being requested from an augmented reality unit 128A-128C.

Additionally, the storage and content manager 112 interrogates an augmented reality unit 128A-128C for virtual reality content and/or related data being downloaded thereto through its proxy. The virtual reality content and/or related data used by the augmented reality unit 128A-128C can be automatically cached using proxy caching, transparent caching, and/or other data storage or caching methods. For example, a proxy server can coordinate with the storage and content manager 112 and/or an augmented reality unit 128A-128C to cache real environment data, room-specific content, spatial mapping data, user-specific data, content usage data, and/or other types of data and configuration inputted or downloaded via the augmented reality unit 128A-128C on a scheduled basis. Further, the storage and content manager 112 continuously manages virtual reality content in various data sources to update the content on a scheduled basis by automatically downloading or scheduling downloads (e.g., during low traffic periods) for any changed content. In this way, the updated content can be accessible to other augmented reality units 128A-128C connected to the network. Similarly, the storage and content manager 112 can de-duplicate all stored content via, for example, a scheduled task.

Virtual reality content can be user-generated data, data from third party sources, and/or a combination thereof. User-generated data is uploaded via an augmented reality unit 128A-128C. Preferably, the storage and content manager 112 maintains the location that was the source of the virtual reality content, for example, using the location data associated with an augmented reality unit 128A-128C. Without limitation, virtual reality content can comprise room-specific content, room-specific configuration, and spatial mapping data, wherein the spatial mapping data includes a detailed representation of real-world surfaces in the environment around the augmented reality unit 128A-128C. Without limitation, the spatial mapping data can include geographic data, location hierarchies, map views, key mapping features. Each user can map a room and the mapping information can be stored in a storage architecture such as the content storage 110 for use by all of the other users connected to the network. The content storage 110 can comprise multi-TB storage and provides physical and virtual byte architecture that is preferably optimized for storage and retrieval of three-dimensional content types. The content storage 110 is further configured to cache contents that are used by any connected augmented reality unit 128A-128C within the network and the contents can be encrypted. If any content comprises confidential information (e.g., protected health information under HIPAA), the non-confidential content is stored separately from PII data to increase privacy. The PII data can be stored in a dedicated PII database that utilizes various security protocols. In this way, the storage and content manager ensures compliance with applicable industry regulations and laws.

The 3D network management 116 is configured to make available in whole or in part, virtual reality content to the augmented reality units 128A-128C. Particularly, the 3D network management 116 can automatically make available content that is specific to, and/or that is of relevance to an augmented reality unit 128A-128C that is credentialed or that is authenticated via the security and auditing management 120. For example, based on the augmented reality unit's 128A-128C physical geographical location information obtained from the storage and storage and content manager 112, the 3D network management 116 can provide virtual reality content that is associated with that physical geographical location, wherein the virtual reality content can be tagged with the same physical geographical location. In another example, the 3D network management 116 can identify the virtual environment in which the user is located or in which the user is immersed, or that the virtual environment that is being displayed by the augmented reality unit 128A-128C. Other predefined criteria such as device type and identification information associated with an augmented reality unit 128A-128C can be used to make available various virtual reality content. Additionally, the 3D network management 116 can also provide configurations that are associated with the available virtual reality content. For example, configurations can comprise display settings (e.g., increased lighting in low light environments) or other location-specific settings. In this way, each connected and authenticated augmented reality unit 128A-128C is automatically configured to set up, store, and read virtual reality content from the storage 110 or the content delivery network 102 based on the physical geographical location and/or room in which the augmented reality unit 128A-128C is located in.

In various embodiments, the public cloud resources 104, content data sources 106, and/or the content storage 110 can import maps and/or location data from third party sources. Physical space management 118 is configured to manage geographical location data and mapping data by connecting spatial files (e.g., shapefile, geoJSON file, etc.), text files, OBJ and FBX image files, or spreadsheets from various data sources (e.g., augmented reality units 128A-128C) corresponding to related locations or spaces. The spatial files comprise actual geometries (i.e., points, lines, polygons, etc.). The text files and spreadsheets can contain point locations in latitude and longitude coordinates or named locations. Various data sources can be consolidated and organized by regions, categories, names, and/or so forth. In this regard, one or more users or an administrative entity can define boundary of one or more custom regions in a virtual environment. Two or more regions may be overlapping or non-overlapping. For example, the regions can be a single room in a building, an area including multiple rooms (i.e., a group of rooms) that may or may not be adjacent to each other, and/or any dynamic boundary of regular or irregular regions that may or may not correspond to a physical boundary. Moreover, a single region can be across multiple floors in a floor plan. Thus, the regions can be arbitrarily defined by a user 126A-126C and/or an administrative entity 140. Virtual reality content or other data associated with a region can be synchronized. For example, virtual reality content can be synchronized among grouped or linked rooms, floors, and/or buildings.

The user management module 114 is configured to manage users accounts and augmented reality units 128A-128C associated with each user 126A-126C in the network. Information related to each user account and augmented reality units 128A-128C associated with a user are stored in a user database 130, wherein the user database 130 includes user profile information 132, user preferences and settings 134, and any personally identifiable information 136. The user profile information 132 comprises, without limitation, user identifier (ID) such as username and password, augmented reality unit identifier, user group, and/or so forth. The augmented reality unit identifier can be associated with the device type, model, serial number, and/or other information about the augmented reality unit. Preferably, the user profile information 132 can be managed by the user that is associated with the user account having the user profile. The user preferences and settings 134 comprise, without limitation, language, display settings, privacy settings, usage settings, and/or so forth. The user preferences and settings 134 can be specific to an augmented reality unit. For example, the user preferences and settings 134 can provide a degree of control for gestures. The user preferences and settings 134 can be controlled by an authenticated user and/or a management console that enables users to manage access to content, processing, Wi-Fi network, and physical space data. The personally identifiable information 136 comprises, without limitation, user's full name, age, contact information, demographic, biometric, medical, and financial information, and/or so forth. It is noted that personally identifiable information 136 is stored separately from other data. In various embodiments, user database 130 further comprises authentication data, wherein the authentication data can be obtained from a credential management entity 138. Users 126A-126C can be organized into one or more groups. In this regard, each user can manually enter a group or receive invitation to a group by, for example, a managing member user and/or an administrative entity 140. In various embodiments, users and groups can be inherited from an active directory or other credential management systems.

The user database 130 can be in communication with the computing device 108, the credential management system 138, and the augmented reality unit 128A-128C. The credential management system 138 can be a software-based system or platform that can provide token signing and encryption keys. Alternatively, the credential management system 138 can comprise hardware security modules that can secure token signing keys within predefined cryptographic boundaries, key management, storage, and redundancy features, and handle requirements for access to resources from different devices and locations. In various embodiments, the security and auditing management 120 can issue and manage digital certificates used for enabling user authentication. Various definable authentications such as multi-factor authentication, SAS certification, Password Authentication Protocol (PAP), challenge-handshake authentication protocol (CHAP), extensible authentication protocol (EAP), database authentication, and/or other authentication methods and protocols can be used. The security and auditing management 120 can also facilitate in authenticating a user using one or more of the aforementioned authentication methods and protocols for the virtual reality content. When the security and auditing management 120 authenticates the user, the user is allowed to access content from the computing device 108. During high traffic periods, the network can limit or restrict external communications to prevent interruptions and improve the content experience.

### Exemplary Computing Device

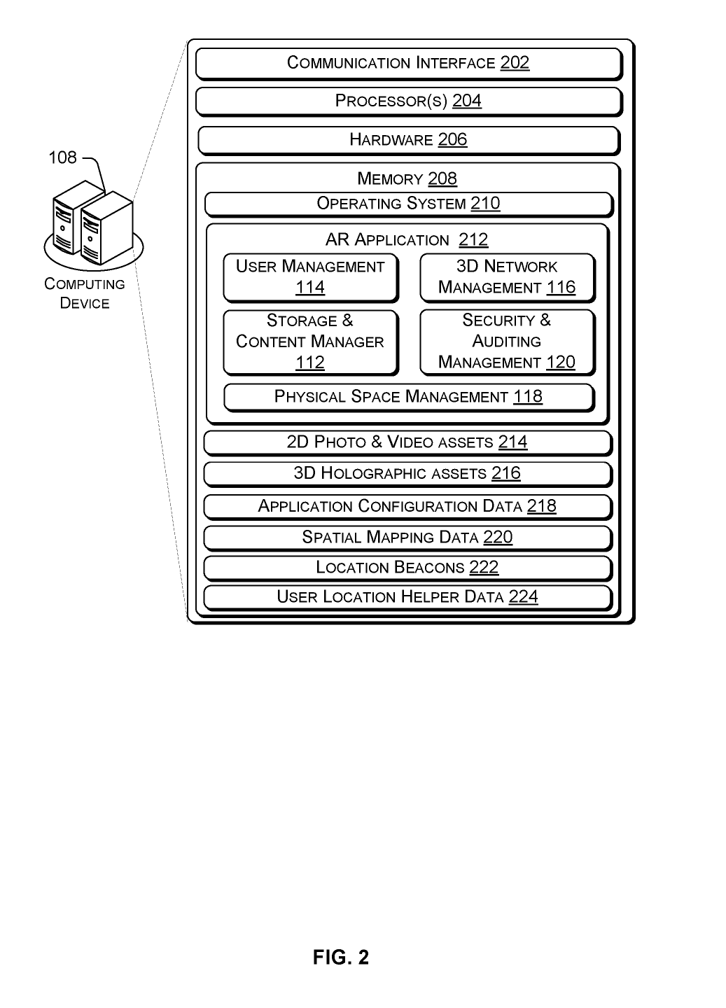

Referring now to FIG. 2, there is shown a block diagram showing various components of an illustrative computing device that implements the virtual reality system of the present invention. The virtual reality system may be implemented by one or more computing nodes 108 of a distributed processing computing infrastructure. The number of computing nodes 108 can be scaled up and down by a distributed processing control algorithm based on data processing demands. For example, during peak performance data processing times, the number of computing nodes 108 that are executing data processing functionalities of the present virtual reality system may be scaled up based on processing demand. However, once the processing demand drops, the number of computing nodes 108 that are executing the data processing functionalities may be reduced. Such scaling up and scaling down of the number of computing nodes 108 can be repeated over and over again based on processing demand.

The computing nodes 108 can include a communication interface 202, one or more processors 204, and memory 208. The communication interface 202 may include wireless and/or wired communication components that enable the one or more computing nodes 108 to transmit data to and receive data from other networked devices. Preferably, the communication interface 202 comprises a high-speed router/bridge so that it can serve as a wireless access point for augmented reality units. For example, the high-speed router/bridge comprises at least a 100 mb Wi-Fi router or 1 gb Ethernet connections. The router/bridge tethers to an existing backbone network to serve as a proxy for requests for content. The computing nodes 108 can communicate with cloud services to transmit data thereto and therefrom, wherein the cloud services can be connected to third-party servers, depending upon embodiments. The computing nodes 108 can be accessed via hardware 206.

The hardware 206 can include additional user interface, data communication, data storage hardware, input/output (I/O) interface, a network interface, and/or data storage hardware. For example, the user interfaces may include a data output device (e.g., visual display, audio speakers), and one or more data input devices. The data input devices may include but are not limited to, combinations of one or more keypads, keyboards, mouse devices, touch screens, devices that accept gestures, microphones, voice or speech recognition devices, and any other suitable devices. The I/O interface may be any controller card, such as a universal asynchronous receiver/transmitter (UART) used in conjunction with a standard I/O interface protocol such as RS-232, RS-422, RS-485, Ethernet, and/or Universal Serial Bus (USB). The network interface may potentially work in concert with the I/O interface and may be a network interface card supporting Ethernet and/or Wi-Fi and/or any number of other physical and/or data link protocols. Accordingly, sensors may interface with the telemetry capture function via a connected port, serial or parallel, and/or via networking.

Memory 208 is any computer-readable media, which may store several software components including an operating system 210 and/or other applications. In general, a software component is a set of computer-executable instructions stored together as a discrete whole. Examples of software components include binary executables such as static libraries, dynamically linked libraries, and executable programs. Other examples of software components include interpreted executables that are executed on a runtime such as servlets, applets, p-Code binaries and Java binaries. Software components may run in kernel mode and/or user mode. Preferably, the memory 208 can comprise a high-speed three-dimensional content storage. For example, the content storage can comprise multi-TB storage and provides physical and virtual byte architecture that can be optimized for storage and retrieval of three-dimensional content types. In various embodiments, content that is stored in the memory 208 can be encrypted.

The memory 208 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or another transmission mechanism. The memory 208 may also include a firewall. In some embodiments, the firewall may be implemented as hardware 206 in the computing device 108.

The processor 204 may be a graphics processing unit (GPU), a central processing unit (CPU), a repurposed graphical processing unit, a dedicated controller such as a microcontroller, and/or so forth. The number of processing units (e.g., GPUs) depends on the number of augmented reality units connected to the system and that needs support. The processing units are optimized for accelerating three-dimensional processing and can be dedicated to multi-user processing. The processing unit resources are available to remote virtual reality or mixed reality applications and render complex three-dimensional assets with high polygon counts. In this regard, the system can offload processing to a GPU connected to another processing unit to optimize processing of complex or multi-user contents. Pre-processing of specific content can be done on the processing unit before it is stored or recalled. The processors 204 and the memory 208 of the computing device 108 may implement an operating system 210 and the security and surveillance system. The operating system 210 may include components that enable the computing device 108 to receive and transmit data via various interfaces (e.g., user controls, communication interface, and/or memory input/output devices), as well as process data using the processors 204 to generate output. The operating system 210 may include a presentation component that presents the output (e.g., display the data on an electronic display, store the data in memory, transmit the data to another electronic device, etc.). Additionally, the operating system 210 may include other components that perform various additional functions generally associated with an operating system.

The memory unit 208 comprises a number of augmented reality application components such as user management 114, 3D network management 116, storage and content manager 112, security and auditing management 120, and physical space management 118. One of more functions of the application 212 components can overlap in whole or in part to provide redundancy and increase reliability. The application 212 may also provide a graphical user interface (GUI) for interacting with one or more of the foregoing application components.

The security and auditing management 120 is configured to authenticate users and/or augmented reality units when establishing connection to the network. In various embodiments, the security and auditing management 120 can authenticate remote users to enable the remote users to view (i.e., in both 2D and 3D) and interact with all virtual reality assets and other users in a virtual environment, wherein the remote users are not located in the environment. In this regard, the security and auditing management 120 can conduct identity authentication using user ID or augmented reality unit ID and one or more items of private information that only a given user should know. Additionally, various definable authentications such as multi-factor authentication, SAS certification, Password Authentication Protocol (PAP), challenge-handshake authentication protocol (CHAP), extensible authentication protocol (EAP), database authentication, and/or other authentication methods and protocols can be used.

In various embodiments, the 3D network management 116 can configure security and auditing. For instance, the 3D network management 116 can enable multiple access modes. Specifically, a lockdown mode can be implemented to prevent changes to any virtual reality content that reside in the memory 208. In this regard, a user can request for permission from the author of the content and/or from an administrative entity in communication with the computing device 108 to make any changes to virtual reality content (e.g., to make corrections to mapping data). Additionally, a lockdown mode can grant connections to allow only certain devices (i.e., augmented reality units) in the network at any given time. For instance, the 3D network management 116 can be configured to allow only augmented reality units that are located in certain geographical areas to connect to the network. In this regard, the 3D network management 116 obtains location information for the augmented reality units from the storage and content manager 112, which is configured to automatically determine augmented reality units' IP address when the augmented reality units are attempting to make a connection to the network. Upon obtaining the augmented reality units' IP address, the 3D network management 116 can allow or reject connection. In another example, the 3D network management 116 can allow or reject connection to the network based on the device type. In this regard, the 3D network management 116 can obtain information about the type of an augmented reality unit by looking up the augmented reality unit's identifier.

If the 3D network management 116 allows connection to an augmented reality unit, the application 212 provides a user interface to set up and automatically configure location or space-specific settings and/or settings that are either similar to the most recently connected augmented reality unit or to a “master” management device (i.e., an augmented reality unit and/or a computing device or node that can be operated by an administrative entity) that has pre-mapped the physical space that the augmented reality unit is in.

The user management 114 is further configured to conduct user and group management to set up specific content and conduct auto-configuration based on specific users and/or augmented reality unit. For example, specific content can automatically launch depending on the device type, device identity, or specific device/application resolution requirements. Additionally, specific augmented reality units can be given higher priority (e.g., in receiving content updates, in establishing and maintaining communication and connection, etc.) in operation, particularly during mission-critical activities. In this regard, the user management 114 identifies augmented reality units to receive particular sets of data comprising specific content and/or configurations. For example, a first augmented reality unit is capable of displaying 3D supported high definition (HD) components and associated with high definition data provided by the computing device 108. A second augmented reality unit is capable of displaying standard definition (SD) components and associated with standard definition data provided through the computing device 108. In various embodiments, augmented reality unit identifiers are provided in data packets sent to and from the augmented reality units. For example, a first augmented reality unit identifier may be provided in a data packet sent to the first augmented reality unit. The first augmented reality unit can then include the first augmented reality unit identifier in data packets sent back to the data source (e.g., the computing device 108). Accordingly, all packets sent and received from the first augmented reality unit can include the same identifier. Similarly, data packets sent and received from the second augmented reality unit can include the second augmented reality unit identifier, and so forth. The identifiers can be provided through a header associated with transmitted data packets.

The memory unit 208 can comprise virtual reality content such as 2D photo and video assets 214 and 3D holographic assets 216 at multiple resolutions and polygon counts. Additionally, the memory unit 208 can comprise application configuration data 218 (e.g., connection string to a database, storage options, etc.), spatial mapping data 220, location beacons 222 to support location-based wayfinding using the application 212, and user location helper data 224 for locating a user operating an augmented reality unit. The application 212 can use spatial mapping data 220 as well as GPS location to place or position holographic or virtual objects or assets in the real world. Utilizing GPS location allows an augmented reality unit to track location against spatial map to place holographic or virtual objects in a logical manner to enable all users to see the holographic or virtual objects or assets in the same location. Some or all of the foregoing contents and/or data can be encrypted, depending upon embodiments. In this regard, the security and auditing management 120 can implement various definable authentications such as a PKI-based authentication protocol, Authentication and Key Agreement (AKA) scheme, and/or other authentication protocol such as multi-factor authentication and SAS certification for data encryption and decryption.

The memory unit 208 further comprises data related to rooms, spaces, and/or buildings in a virtual environment. The data related to rooms, spaces, and/or buildings in a virtual environment can be obtained from one or more augmented reality units. In this regard, the memory unit 208 can receive from a first augmented reality unit, data defining a first room and from a second augmented reality unit, data defining a second room, wherein the first room and the second room can be in the same building in a virtual environment. The physical space management 118 is configured to manage geographical location data and mapping data by connecting spatial files (e.g., shapefile, geoJSON file, etc.), text files, or spreadsheets from various data sources (e.g., augmented reality units 128A-128C) corresponding to related locations or spaces. The storage and content manager 112 can maintain the location that was the source of the virtual reality content and cache all contents that are uploaded, downloaded, accessed, obtained, transmitted, and/or otherwise used by any connected augmented reality units within the network.

Upon receiving data, the storage and content manager 112 synchronizes data pertaining to rooms, spaces, and/or buildings in the virtual environment between the memory unit 208 and one or more augmented reality units in a bi-directional manner. Preferably, synchronization and updates can occur at regular intervals. If any one of the users requests a newer version of existing content via an augmented reality unit, the storage and content manager 112 automatically updates and stores the newer version of the existing content for all users' augmented reality unit. Thus, setting up a single augmented reality unit for a physical space allows other augmented reality units to clone the setup of the first augmented reality unit, thereby accelerating subsequent augmented reality unit setup.

One computing device 108 can manage, store, audit, deliver, and/or provide virtual reality content for a single region (e.g., a single room). In this regard, two or more devices 108 can be linked to operate in concert to manage, store, audit, deliver, and/or provide virtual reality content for multiple regions. 2D and/or 3D images, pictures, videos, maps, objects, and/or views of adjacent regions can be stitched together via, for example, a physical space management 118 or an image preprocessing module, or augmented with other data before delivery to an augmented reality unit. In this way, one or more computing devices 108 can provide shared virtual reality experiences such as 360-degree virtual tours by making available virtual reality content for more regions. Preprocessing 360-degree images and videos before delivery to augmented reality units reduces processing power, thereby prolonging battery life and reducing overall heat output of the augmented reality units and/or other computing devices. Alternatively, one computing device 108 can manage, store, audit, deliver, and/or provide virtual reality content for a plurality of regions (e.g., multiple rooms) in a virtual environment, for example, by serving as a central repository.

### Example Processes

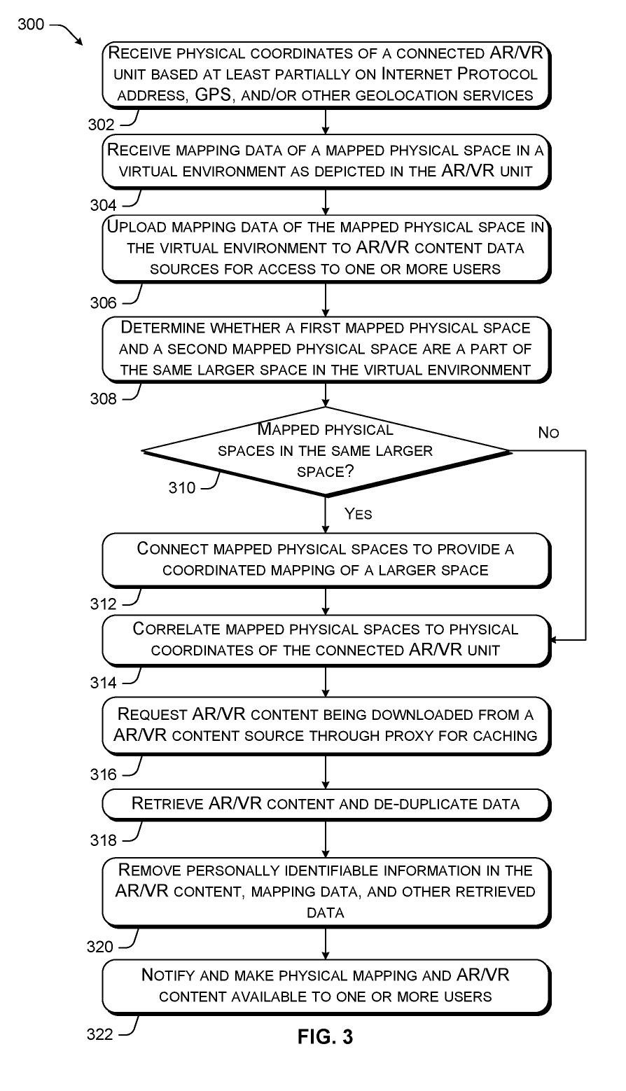

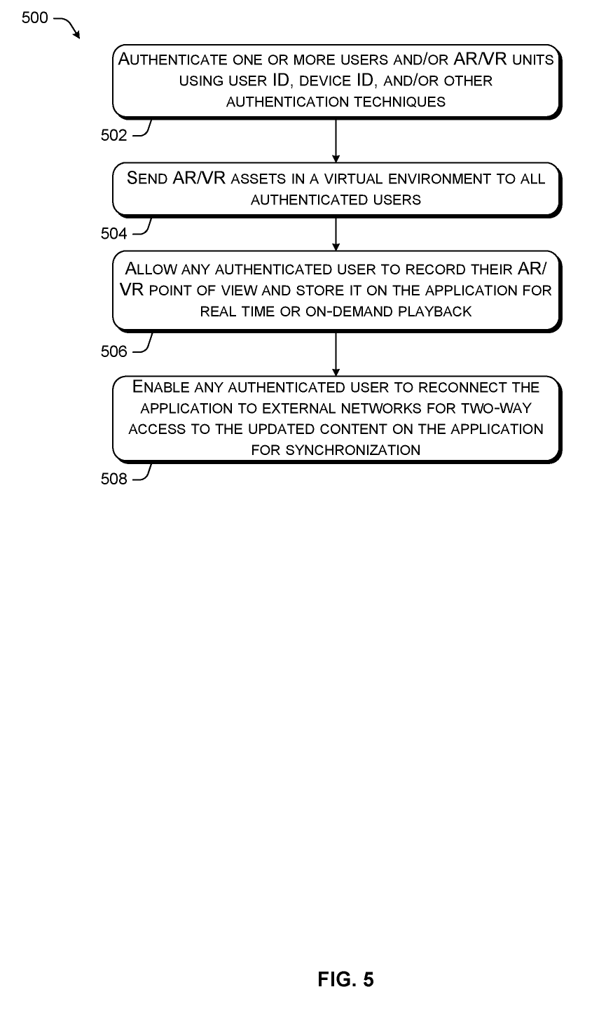

FIGS. 3 and 5 present illustrative processes 300-500 for providing virtual reality content as described herein. Each of the processes 300-500 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the processes 300-500 are described with reference to the architecture 100 of FIG. 1.

FIG. 3 shows a flow diagram of an example process 300 for mapping a virtual environment to a corresponding physical location in order to cache virtual reality contents. At block 302, the storage and content manager of the virtual reality application receives physical coordinates of a connected augmented reality unit based at least partially on IP address, GPS, and/or other geolocation services. At block 304, the physical space management 118 receives spatial mapping data of a mapped physical space in a virtual environment as depicted in the augmented reality unit. At block 306, the storage and content manager uploads mapping data of the mapped physical space in the virtual environment to virtual reality content data sources for access to one or more users via augmented reality units. In various embodiments, the content data source comprises a content storage that is operatively connected to the storage and content manager.

At block 308, the physical space management determines whether a first mapped physical space and a second mapped physical space are a part of the same larger space in the virtual environment or related to the same space. The first mapped physical space and the second mapped physical space can be grouped together such that they are in the same region. For example, the first mapped physical space and the second mapped physical space can be grouped by location. In various embodiments, stilled images and/or video related to the first and second mapped physical spaces can be stitched together via a physical space management and/or an image preprocessor before being delivered to an augmented reality unit. At decision block 310, if the two mapped spaces are in the same larger space (yes response from the decision block 310), the physical space management connects mapped physical spaces to provide a coordinated mapping of a larger space at block 312.

At block 314, the physical space management can correlate mapped physical spaces to physical coordinates of the connected augmented reality unit, wherein the physical coordinates of the connected augmented reality unit can be obtained from the storage and content manager. At block 316, the storage and content manager requests virtual reality content being downloaded from an augmented reality unit source through proxy for caching. At block 318, the storage and content manager retrieves virtual reality content from the augmented reality unit and de-duplicates data on a scheduled basis. At block 320, the user management removes any PII in the virtual reality content, mapping data, and/or other retrieved data from an augmented reality unit. PII can be stored separately in a user database 130. At block 322, the application makes physical mapping and virtual reality content available to one or more users. In this regard, the application can transmit notifications to one or more augmented reality units associated with the one or more users.

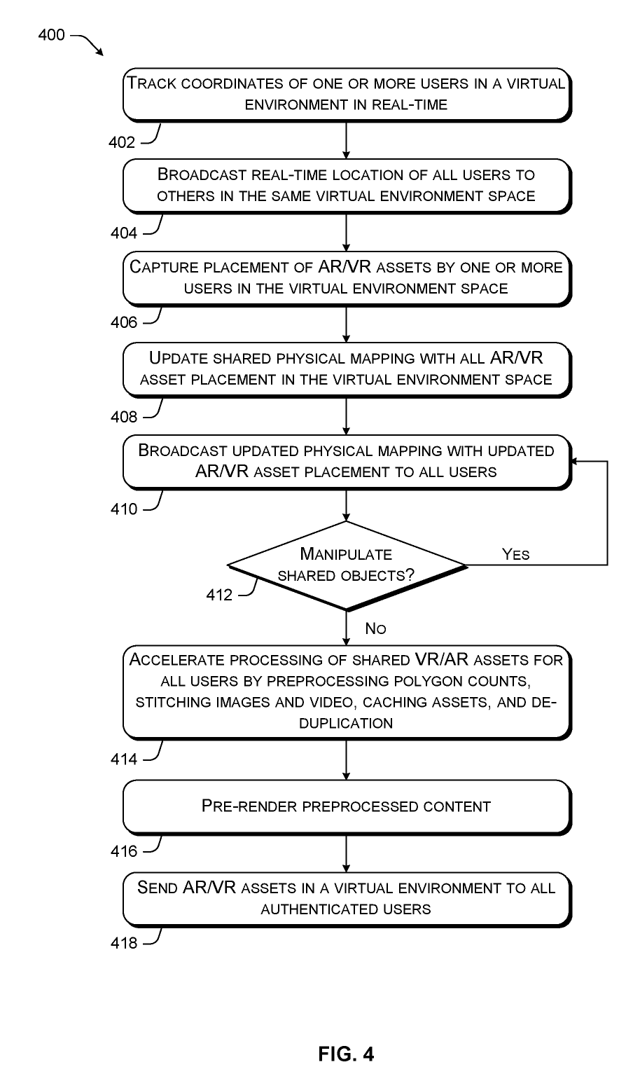

FIG. 4 shows a flow diagram 400 of an example process for maintaining location-specific virtual reality assets. At block 402, the storage and content manager can track coordinates of one or more users in a virtual environment in real time. In various embodiments, the storage and content manager can implement GPS to track the users' locations. At block 404, the user management broadcasts real-time location of all users to others in the same virtual environment space. In this way, users can coordinate movement in order to conduct mission. For example, different users can map different spaces to prevent two or more users from mapping the same spaces.

At block 406, the physical space management can capture placement of virtual reality assets (e.g., 3D holographic assets) by one or more users in the virtual environment space. At block 408, the storage and content manager can update shared physical mapping with all virtual reality placements in the virtual environment space. At block 410, the application can broadcast updated physical mapping with updated virtual reality asset placement to all users. For example, the application can display notifications on augmented reality units. At decision block 412, the storage and content manager determines whether any shared objects have been manipulated. Particularly, the storage and content manager can determine whether a 3D holographic asset has been moved. If a shared object has been manipulated (yes response from the decision block 412), the application can rebroadcast updated physical mapping with updated virtual reality asset placement to all users.

At block 414, the physical space management accelerates processing of shared virtual reality assets for all users by preprocessing polygon counts, stitching still images and/or videos to provide 360-degree views, caching assets, and conducting data de-duplication. In various embodiments, the system can include a database or a data source that is dedicated to deduplicated data. At block 416, one or more GPUs can pre-render preprocessed content to further accelerate processing. At block 418, the storage and content manager can send virtual reality assets in a virtual environment to all authenticated users. In this regard, only users meeting predefined criteria can access the virtual reality assets. For example, users located in specific locations or users operating specific device types can access the virtual reality assets.

FIG. 5 shows a flow diagram of an example process for conducting security and auditing management. At block 502, the user management authenticates one or more users using a user identifier and/or augmented reality units using a device identifier. In this regard, various authentication techniques and security protocols can be used. At block 504, the storage and content manager can transmit virtual reality assets in a virtual environment to all authenticated users. In some embodiments, the virtual reality assets can be encrypted such that only credentialed users can decrypt the assets to access the same. At block 506, the storage and content manager can permit one or more authenticated users to record their virtual reality point of view using an augmented reality unit and store it on the application platform for real-time or on-demand playback. At block 508, the application platform allows any authenticated user to reconnect the application to external networks for two-way access to the updated content on the application for synchronization.

### Scenario for Operation

The following lists of events may be considered a more concrete example of the functionality of the present invention, in a realistic scenario involving a single user. In this scenario, the functionality of the system, as more generally shown in FIG. 1, is designated by the term “Reality Blade,” which might be deemed to be the commercial trade name of such a product/service offering. It is noted that the present method is not limited to the following method steps in any specific or particular order, depending upon embodiments.

Step 1: A user obtains Reality Blade hardware or an equivalent hardware configuration and establishes a connection to a network.

Step 2: The user obtains Reality Blade application either as a license or as an online subscription to a web offering such as a mobile site, a mobile application, a website, or the like.

Step 3: The application guides the user through connecting to the Reality. Blade SSID and disconnecting from pre-existing connectivity. When complete all connectivity and external file operations will be run through the Reality Blade.

Step 4: After successfully authenticating to the Reality Blade, the application ensures that all file open/file save operations that originate from local applications are brokered through the Reality Blade.

Step 5: If a user's headset supports spatial mapping, the application polls the GPS and/or prompts the user to identify his or her location.
a) If a physical space has already been mapped by another user of the system, the user will connect to that existing layout information, thereby eliminating any need to remap the same physical space.

Step 6: The user can manage configurations and toggle a number of features (e.g., air gapping from the public network, checking the availability of remote GPU resources, and managing the 2D and 3D file assets that have been stored in the Reality Blade) via the application.

Step 7: The application searches for all other users connected to the Reality Blade and reports back the coordinates and nickname of each user to other virtual reality or mixed reality applications. Each of the users can opt to follow or un-follow other connected users.

Step 8: On an ongoing basis, the application manages the file assets, and can extract and adjust polygon counts for 3D assets, set permissions by user account and/or application, and synchronize content with external data sources on the public network. Additionally, the system can be configured to alert administrators when any one of predefined conditions is met in the activity log (e.g., a number of bad login attempts, high bandwidth utilization, etc.).

### CONCLUSION

It is therefore submitted that the instant invention has been shown and described in what is considered to be the most practical and preferred embodiments. It is recognized, however, that departures may be made within the scope of the invention and obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system, comprising:
a memory unit having a set of instructions stored thereon, wherein said memory unit is operatively connected to a processing unit that is configured to execute said set of instructions to:
receive mapping data of one or more mapped physical spaces in a virtual environment from an augmented reality unit having a corresponding device identifier;
receive a request comprising the device identifier corresponding to the augmented reality unit, and a request for a virtual reality content, wherein the virtual reality content comprises the mapping data;
retrieve the virtual reality content, from at least one content delivery network, based at least in part on the device identifier; and
deliver the virtual reality content to the augmented reality unit.

2. The system of claim 1, wherein the processing unit is further configured to:
determine a real-time location of the augmented reality unit; and
correlate the one or more mapped physical spaces to the real-time location of the augmented reality unit.

3. The system of claim 1, wherein the processing unit is further configured to:
determine whether a first mapped physical space and a second mapped physical space are related;
if the first mapped physical space and the second mapped physical space are related, connect the mapping data associated with the first mapped physical space and the second mapped physical space.

4. The system of claim 1, wherein the processing unit is further configured to cache the mapping data into a high-speed three-dimensional content storage.

5. The system of claim 1, wherein the processing unit is further configured to:
receive the mapping data of the one or more mapped physical spaces in the virtual environment from a first augmented reality unit;
receive a first request comprising a second device identifier corresponding to a second augmented reality unit, and a second request for the virtual reality content, wherein the virtual reality content comprises the mapping data obtained from the first augmented reality unit;
retrieve the virtual reality content, from the at least one content delivery network, based at least in part on the second device identifier; and
deliver the virtual reality content to the second augmented reality unit.

6. The system of claim 1, wherein the request utilizes a multi-factor authentication.

7. The system of claim 1, further comprising one or more sensors operatively connected to the processing unit.

8. A computer-implement method, comprising the steps of:
receiving mapping data of one or more mapped physical spaces in a virtual environment from an augmented reality unit having a corresponding device identifier, wherein the augmented reality unit is operated by a user having a user account comprising user profile and settings preferences;
capturing placement of one or more virtual reality assets by the user in the virtual environment;
caching virtual reality content used by the augmented reality unit into a high-speed three-dimensional content storage, wherein the virtual reality content comprises the mapping data and the one or more virtual reality assets;
receiving a request comprising the device identifier corresponding to the augmented reality unit, and a request for the virtual reality content; and
delivering the virtual reality content to the augmented reality unit.

9. The method of claim 8, wherein the mapping data and the one or more virtual reality assets comprise deduplicated data.

10. The method of claim 8, further comprising the steps of:
receiving an updated virtual reality content of the one or more mapped physical spaces in the virtual environment from a first augmented reality unit;
caching the updated virtual reality content into the content storage; and
delivering the updated virtual reality content to a second augmented reality unit.

11. The method of claim 8, further comprising the steps of tracking coordinates of the user in the virtual environment in real-time.

12. The method of claim 8, wherein the virtual reality content is associated with defined rooms, buildings, and spaces in the virtual environment, further wherein the defined rooms, buildings, and spaces can be grouped into a single region.

13. One or more non-transitory computer-readable media storing computer-executable instructions that upon execution cause one or more processors to perform acts comprising:
receiving mapping data of one or more mapped physical spaces in a virtual environment from an augmented reality unit having a corresponding device identifier;
receiving a request comprising the device identifier corresponding to the augmented reality unit, and a request for a virtual reality content, wherein the virtual reality content comprises the mapping data, further wherein the request utilizes a multi-factor authentication;
retrieving the virtual reality content, from at least one content delivery network, based at least in part on the device identifier; and
delivering the virtual reality content to the augmented reality unit.

14. The one or more non-transitory computer-readable media of claim 13, wherein the one or more non-transitory computer-readable media comprises an on-premise server.

15. The one or more non-transitory computer-readable media of claim 13, wherein the one or more non-transitory computer-readable media comprises a firewall.

16. The one or more non-transitory computer-readable media of claim 13, the acts further comprising preprocessing images and videos related to the virtual reality content for pre-rendering.

17. The one or more non-transitory computer-readable media of claim 13, the acts further comprising serving an appropriate resolution of pixels and number of polygons based at least partially on the augmented reality unit.

18. The one or more non-transitory computer-readable media of claim 13, the acts further comprising offloading processing to a graphics processing unit to optimize processing of complex or multi-user contents.

19. The one or more non-transitory computer-readable media of claim 13, the acts further comprising:
receiving an updated virtual reality content of the one or more mapped physical spaces in the virtual environment from a first augmented reality unit;
caching the updated virtual reality content into the content storage;
reconnecting to one or more external networks for two-way access to the updated virtual reality content for synchronization; and
delivering the updated virtual reality content to a second augmented reality unit.

20. The one or more non-transitory computer-readable media of claim 13, wherein access to the virtual reality content is limited based in part on a device type and IP address associated with the augmented reality unit.
